(19) United States
(12) Patent Application Publication
(10) Pub. No.: US 2008/0142490 A1
(43) Pub. Date: Jun. 19, 2008

(54) GAS-SHIELDED ARC WELDING METHOD

(75) Inventors: Reiichi Suzuki, Fujisawa-shi (JP); Yu Umehara, Fujisawa-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko Sho ( Kobe Steel, Ltd.), Kobe-shi (JP)

(21) Appl. No.: 11/935,581

(22) Filed: Nov. 6, 2007

(30) Foreign Application Priority Data
Dec. 13, 2006 (JP) 2006-335823

(51) Int. Cl. B23K 9/16

(52) U.S. Cl. 219/74

(57) ABSTRACT

A gas-shielded arc welding method uses a shielding gas and a solid wire for pulsation welding. The solid wire contains S, Si, Mn, C and P in predetermined S, Si, Mn, C and P contents, and other elements including Fe and unavoidable elements. A pulsating current used for pulsation welding has a peak current Iₚ of 350 A or above and a pulse peak duration Tₚ between 0.5 and 2.0 ms. The shielding gas is a mixed gas containing 75 to 98% by volume Ar and others including at least either of CO₂ and O₂. The gas-shielded arc welding method can suppress the generation of spatters regardless of welding speed even if the welding speed is high, and can form a wide, flat bead having uniform toes. A weld metal produced by the gas-shielded arc welding method is resistant to cracking and excellent in preventing the formation of blowholes.

### BACKGROUND OF THE INVENTION

1. Field of the Invention

The present invention relates to a gas-shield welding method for pulsed-arc welding using a solid wire and, more particularly, to a gas-shielded arc welding method applicable to high-speed welding.

2. Description of the Related Art

The automobile industry requires the improvement of the efficiency of welding processes, particularly the enhancement of welding speed for cost reduction in recent years. If welding speed is increased, weld toes become irregular due to the agitation of a molten pool and a narrow, convex bead is formed due to increased arc force. The convex bead, in particular, narrows the allowable range of displacement of the axis of a weld from a desired weld line and often causes defective welding, liable to cause fatigue fracture by increasing stress concentration factor at the joint of the base metal and the weld toes. When a weldment has convex beads, the convex beads often interfere with another work in assembling the weldment and the work and the beads obstructing assembly need to be grounded. Therefore, it has been desired to develop a welding method capable of carrying out high-speed welding, of forming a bead having regular weld toes, and of forming a flat, wide bead.

Tandem arc welding methods using two electrodes to avoid increasing arc force have been proposed for high-speed welding under the foregoing circumstances.

Many tandem ac welding control methods are disclosed. A tandem welding control method proposed in “Tandemu Aaku Yosetsu Robotto Sisutemuno Kaihatsu”, Shinkou Yosetsu Gijutsu Gaido No. 384, pp. 6-10 (April, 2002) (Reference 1) controls welding operations by a tandem arc welding robot system. A two-electrode pulsed arc welding control method disclosed in JP-A 2004-1033 (Reference 2) specifies predetermined relation among peak current duration, base current duration and pulse period, and uses two arcs generated between a first welding wire and a base metal and between a second welding wire and the base metal.

A technique disclosed in Jpn. Pat. No. 3808251 (Reference 3) intended to enhance welding speed by coordinating components of a welding wire specifies ranges of the respective amounts of minor elements contained in a welding wire to improve short circuit stability and forms, wide, flat beads by optimizing the viscosity of weld metals. A high-speed gas-shielded arc welding wire disclosed in JP-A S61-165294 (Reference 4) contains C, O, Mn and Ti as components for stabilizing arc to form a bead in a satisfactory shape and Al as a strong deoxidizer for preventing the formation of small blowholes.

A technique disclosed in JP-A H5-305476 (Reference 5) increases the S content of a welding wire to use the low melting point compound producing effect and effect on adjusting the surface tension of a molten metal of S for forming beads in a satisfactory shape and increasing welding speed in welding thin sheets by reducing the viscosity and surface tension of a molten metal.

A gas-shielded arc welding method disclosed in JP-B S63-27120 (Reference 6) capable of forming a wide bead uses a shielding gas having a proper nitrogen concentration for arc stabilization and forming a wide bead.

Those known gas-shielded arc welding methods have the following problems.

The tandem arc welding methods mentioned in References 1 and need large-scale welding equipment and high welding cost. In welding general automotive parts, a welding torch needs to be moved so as to dodge clamps clamping the automotive parts to suppress thermal deformation. Therefore, it is difficult to apply the tandem arc welding methods using a large torch head to welding general automotive parts.

The technique mentioned in Reference 3, uses a welding wire has a very low Mn content as compared with that of standard solid wire specified in Z3312, JIS, contains small amounts of Cr and Ti for improving arc stability, and uses CO₂ as a shielding gas. The CO₂ used as a shielding gas produces many spatters. When this technique intended for high-speed welding is applied to welding at a low welding speed of 1 m/min or below, a bead is formed in a bad shape.

The high-speed gas-shielded arc welding wire disclosed in Reference 4 is used for a CO₂ gas shielded arc welding. Therefore, many spatters are produced, and beads cannot be formed in a satisfactory shape when the welding speed is in a low welding speed range. The main purpose of this high-speed gas-shielded arc welding wire is to stabilize a short ark and to prevent the formation of small blowholes, and any means for forming a wide bead is not taken into consideration in developing this high-speed gas-shielded arc welding wire.

Increase in the S content intended by the technique mentioned in Reference 5 is indubitably effective in forming a wide, flat bead. However, the wide, flat bead is not uniform in width, has a wavy shape and bad appearance. Moreover, stress concentrated on the peaks of the wavy shape reduces fatigue strength. The dislocation of the wire from a desired position sometime causes incomplete penetration.

The gas-shielded arc welding method mentioned in Reference 6 uses a shielding gas containing a proper amount of nitrogen. Nitrogen embrittles carbon steels markedly. Therefore, this gas-shielded arc welding method embrittles carbon steels. This gas-shielded arc welding method can form a wide bead only when welding speed is 50 cm/min or below and cannot be applied to high-speed welding.

The conventional gas-shielded arc welding method using a welding wire of some composition causes cracking or blowhole formation. The general welding method using a commercial power source is liable to make the arc unstable and to produce spatters.

### SUMMARY OF THE INVENTION

The present invention has been made in view of such problems and it is therefore an object of the present invention to provide a gas-shielded arc welding method capable of suppressing producing spatters during high-speed welding regardless of welding speed and of forming uniform weld toes, of forming a wide, flat bead, and excellent in preventing cracking and forming blowholes.

The inventors examined the following matters to solve the foregoing problems.

Difficulty in forming a bead in a sufficiently big width and the formation of a convex bead are problems in high-speed welding. Causes of a narrow, convex bead are as follows.

A molten metal directly below an arc is pushed in a rearward direction opposite a forward direction in which a welding torch is advanced and rises. Surface tension, which minimizes the area of the surface of a liquid, acting on the surface of the molten metal tends to maintain the shape of the risen molten metal as long as possible against gravity. The higher the surface tension, the higher the force tending to maintain the shape of the risen molten metal and hence the lower is the speed of the risen molten metal sinking toward the base metal. Consequently, the molten metal has difficulty in spreading. The temperature of the molten metal drops with time and the molten metal solidifies before the same flattens. Thus a narrow convex bead is formed. When welding speed is high, welding current is increased necessarily to increase deposition rate. Therefore, the molten metal is pushed rearward more strongly and is caused to rise by increased arc force. Consequently, the higher the welding speed, the narrower the width of the bead and the greater the convexity of the bead.

A bead can be formed as wide and flat as possible by making the risen molten metal sink rapidly toward the base metal. Since the lower the surface tension acting on the surface of the molten metal, the lower the force tending to minimize the area of the surface of the molten metal. Therefore, the risen molten metal sinks under the influence of gravity at a high sinking speed when the surface tension acting on the risen molten metal is low. Consequently, the risen molten metal sinks toward the base metal before the same solidifies and forms a flat, wide bead.

Increase in the oxygen (O) and sulfur (S) concentration of the molten metal is an effective means for reducing the surface tension. Increasing the S concentration is particularly effective in reducing the surface tension. However, when the surface tension acting on the surface of the molten meal is low, waves are caused to rise easily in the molten metal by disturbance and the bead is liable to be formed in an irregular shape.

A welding method using a commercial power source uses a comparatively low current for welding thin sheets and transfers globules in a transfer mode which alternately repeats explosive firing and short-circuit arc quenching, which is called a short-circuit globule transfer mode or a globule transfer mode. The inventors of the present invention found through many experiments and observation that this transfer mode unavoidably disturbs the surface of the molten metal, adversely affecting the shape of weld toes to form irregular weld toes.

The inventors of the present invention also found that the increase of the mean width of a bead is not sufficiently effective in improving fatigue strength or in stably reducing the displacement of a point aimed at by the welding wire, and that a bead needs to be formed in a uniform width and all the parts of a bead need to be formed in a fixed big width.

The inventors of the present invention made studies and concluded that those problems can be solved by greatly reducing surface tension acting on the surface of a molten metal and statically transferring globules so that the molten metal may not be jolted. The inventors succeeded in forming a wide, flat bead having satisfactorily uniform weld toes by maintaining a molten metal in a very static state by transferring globules in a spray transfer mode in which the short-circuit arc quenching does not occur, using a low pulsating current of a predetermined pulse waveform. A gas-shielded arc welding method of the present invention can form a wide bead having a satisfactorily uniform width.

The present invention provides a gas-shielded arc welding method using a shielding gas and a solid wire for pulsation welding, wherein the solid wire contains 0.040 to 0.200% by mass S, 0.20 to 1.50% by mass Si, 0.50 to 2.50% by mass Mn, 0.15% by mass or below C, 0.025% by mass or below P and other elements including Fe and unavoidable impurities, a pulsating current used for pulsation welding has a peak current Iₚ of 350 A or above and a pulse peak duration Tₚ between 0.5 and 2.0 ms, and the shielding gas is a mixed gas containing 75 to 98% by volume Ar and others including at least either of CO₂ and O₂.

When the solid wire having a S content in the foregoing predetermine range is used, a molten metal has low viscosity and low surface tension. When a pulsating current having a peak current Iₚ in the foregoing range is used for pulsation welding, welding can be carried out in a spray transfer mode in which short-circuit arc quenching does not occur. When a pulsating current having a pulse peak duration Tₚ in the foregoing range is used for pulsation welding, the fusion of the wire can be synchronized with the waveform of the pulsating current and, consequently, stable globule transfer is continued and the arc is stabilized.

Since the solid wire has the predetermined Si and the predetermined Mn content, the molten metal is deoxidized to improve the blowhole preventing property of the molten metal. Hot cracking can be suppressed by limiting the C and the P content of the solid wire. Arc for spray transfer is stabilized by using the specified shielding gas.

The present invention further provides a gas-shielded arc welding method using a shielding gas and a solid wire for pulsation welding, wherein the solid wire contains 0.040 to 0.200% by mass S, 0.20 to 1.50% by mass Si, 0.50 to 2.50% by mass Mn, 0.15% by mass or below C, 0.025% by mass or below P, 0.10% by mass or below Ti, 0.20% by mass or below Al, 0.50% by mass or below Mo, 0.30% by mass or below Nb, 0.30% by mass or below V, 1.00% by mass or below Cr, 1.00% by as or below Ni and other elements including Fe and unavoidable impurities, a pulsating current used for pulsation welding has a peak current Iₚ of 350 A or above and a pulse peak duration Tₚ between 0.5 and 20 ms, and the shielding gas is a mixed gas containing 75 to 98% by volume Ar and others including at least either of CO₂ and O₂.

When the solid wire having a S content in the foregoing predetermine range is sued, a molten metal has low viscosity and low surface tension. When a pulsating current having a peak current Iₚ in the foregoing range is used for pulsation welding, welding can be carried out in a spray transfer mode in which short-circuit arc quenching does not occur. When a pulsating current having a pulse peak duration Tₚ in the foregoing range is used for pulsation welding, the waveform of the pulsating current can be synchronized with the fusion of the wire and, consequently, stable globule transfer is continued and the arc is stabilized.

Since the solid wire has the predetermined Si and the predetermined Mn content, the molten metal is deoxidized to improve the blowhole preventing property of the molten metal. Hot cracking can be suppressed by limiting the C and the P content of the solid wire. Since the Ti, the Al, the Mo, the Nb, the V, the Cr and the Ni content of the solid wire are not greater than the specified upper limits, respectively, the rise of the viscosity and surface tension of the molten metal can be suppressed. Arc for spray transfer is stabilized by using the specified shielding gas.

The gas-shielded arc welding method of the present invention can suppress spattering not only in low-speed welding, but also in high-speed welding, and can form a wide, flat bead having uniform weld toes.

The fatigue characteristic of joints can be improved by moderating stress concentration on weld toes. The allowable range of displacement of the axis of a weld from a desired weld line can be widened, and cracking and blowhole formation can be prevented.

### BRIEF DESCRIPTION OF THE DRAWINGS

FIG. 1 is a typical view of assistance in explaining the waveform of a pulsating current and a globule transfer mode;

FIG. 2A is a typical sectional view of a molten pool (molten metal) formed by welding using a commercial power source;

FIG. 2B is a typical sectional view of a molten pool (molten metal) formed by welding using a pulsating power source providing pulsating power of a predetermined waveform;

FIGS. 3A, 3B and 3C are typical perspective views of beads formed under different welding conditions specifying solid wires respectively having different S contents and different welding currents, respectively;

FIG. 4 is a typical sectional view of assistance in explaining the relation between the shape of a groove for horizontal lap fillet welding and bead width; and

FIG. 5 is a typical view of assistance in explaining a method of determining the width of a bead formed by horizontal lap fillet welding.

### DESCRIPTION OF THE PREFERRED EMBODIMENTS

Preferred embodiments of the present invention will be described. A gas-shielded arc welding method in a preferred embodiment according to the present invention is a pulsation welding method using a solid wire, a pulsating welding current and a pulsating voltage.

The solid wire has a S content between 0.040 and 0.200% by mass and contains predetermined amounts of other elements including Si, Mn, C and P, and other elements including F and unavoidable impurities. A pulsating current used for the pulsation welding method has a peak current Iₚ of 350 A or above and a peak duration Tₚ between 0.5 and 20 ms. A specified shielding gas is used.

Solid Wire

Generally, welding wires are classified into solid wires and flux-cored wires having a flux core. The pulse waveform and the fusion of the solid wire become asynchronous and arc is unstable unless the pulsating welding makes a molten metal as uniform as possible. Therefore, it is essential for the pulsating welding method of the present invention to use a solid wire. The solid wire may be either Cu plated or not plated. A Cu plating of the solid wire has not effect at all on the condition of the bead including width and flatness of the bead and the uniformity of weld toes. Therefore, the solid wire may be either plated or not plated.

Conditions on the components of the solid wire (hereinafter, referred to simply as “wire” sometimes) will be explained. The solid wire contains S, Si, Mn, C and P.

S Content: 0.040 to 0.200% by mass

The viscosity and surface tension of a molten metal can be reduced by increasing the S content of the wire. When the S content is 0.040% by mass or above, the surface tension is low, a flat bead can be formed, and hence a bead having a sufficiently big width can be formed. Preferably, the S content of the wire is 0.050% by mass or above in order to make a bead wider and flatter. When the S content of the wire is below 0.040% by mass, the wire cannot reduce the surface tension satisfactorily, a bead cannot be formed in a sufficient width, and a convex bead is formed. When the S content of the wire is above 0.200% by mass, solidification cracking is liable to occur. Therefore, the upper limit of the S content is 0.200% by mass.

Si Content: 0.20 to 1.50% by mass

Silicon (Si) is a deoxidizing element that influences the blowhole preventing property, viscosity and surface tension of the molten metal. When the Si content of the wire is below 0.20% by mass, the molten metal cannot be satisfactorily deoxidized and blowholes are formed in the molten metal depending on the composition of the gas. Therefore, the Si content of the wire for general purposes is 0.20% by mass or above. When the Si content of the wire is above 1.50% by mass, the molten metal has an excessively high viscosity and an excessively high surface tension, and a wide, flat bead cannot be formed. Preferably, the Si content of the wire is 1.20% by mass or below.

Mn Content: 0.50 to 2.50 by mass

Manganese (Mn) also is a deoxidizing element that influences the blowhole preventing property, viscosity and surface tension of the molten metal. When the Mn content of the wire is below 0.50% by mass, the molten metal cannot be satisfactorily deoxidized and blowholes are formed in the molten metal depending on the composition of the gas. Therefore, the Mn content of the wire for general purposes is 0.50% by mass or above. When the Mn content of the wire is above 2.50% by mass, the molten metal has an excessively high viscosity and an excessively high surface tension, and a wide, flat bead cannot be formed. Preferably, the Mn content of the wire is 1.50% by mass or below.

C Content: 0.15% by mass or below

Cracking resistance is low if the C content of the wire is excessively high. Some shape of a groove and some welding conditions cause hot cracking. A suitable C content is 0.15% by mass or below. The reduction of the C content to any extent has no detrimental effect at all and hence it is unnecessary to specify a lower limit to the C content. However, the cost increases as the C content decreases. Therefore, from the industrial point of view, a practical lower limit to the C content may be about 0.01% by mass.

P Content: 0.025% by mass or below

Phosphor (P) promotes hot cracking markedly. Therefore, it is desirable to reduce the P content to the lowest possible value. A P content of 0.025% by mass or below does not practically cause cracking. A preferable C content is 0.018% by mass or below.

Other elements: Fe and unavoidable impurities

The solid wire contains the foregoing elements and other elements including Fe and unavoidable impurities.

Possible unavoidable impurities are, for example, 0 and Zr. The solid wire may contain those unavoidable impurities in impurity contents that will not affect adversely to the effect of the present invention. It is preferable that each of the impurity contents is 0.050% by mass or below.

The solid wire intended for use by the gas-shielded arc welding method of the present invention may contain 0.040 to 0.200% by mass S, predetermined amounts of Si, Mn, C and P, at least one of Ti, Al, Mo, Nb, V, Cr and Ni, and other elements including Fe and unavoidable impurities.

Although it is desirable that the solid wire does not contain Ti, Al, Mo, Nb, V, Cr and Ni, i.e., the Ti, the Al, the Mo, the Nb, the V, the Cr and the Ni content of the solid wire are 0% by mass, the solid wire may contain those elements, provided that those elements do not affect adversely to the effect of the present invention. The solid wire may have a Ti, an Al, a Mo, a Nb, a V, a Cr and a Ni content meeting the following conditions.

Reasons for limiting the Ti, the Al, the Mo, the Nb, the V, the Cr and the Ni content of the solid wire will be explained.

Ti Content: 0.10% by mass or below, Al Content: 0.20% by mass or below, Mo Content: 0.50% by mass or below, Nb Content: 0.30% by mass or below, V Content: 0.30% by mass or below, Cr Content: 1.00% by mass or below, Ni Content: 1.00% by mass or below

All of Ti, Al, Mo, Nb, V, Cr and Ni are elements that increase the viscosity and surface tension of the molten metal and make the formation of a wide, flat bead difficult. Therefore it is desirable that the solid wire contains as small amounts as possible of those elements. Practically, any problems do not arise when the Ti, the Al, the Mo, the Nb, the V, the Cr and the Ni content of the solid wire are 0.10% by mass or below, 0.20% by mass or below, 0.50% by mass or below, 0.30% by mass or below, 0.30% by mass or below, 1.00% by mass or below and 1.00% by mass or below, respectively.

The gas-shielded arc welding method is a pulsation welding method using the solid wire containing the foregoing elements. The pulsation welding method will be described.

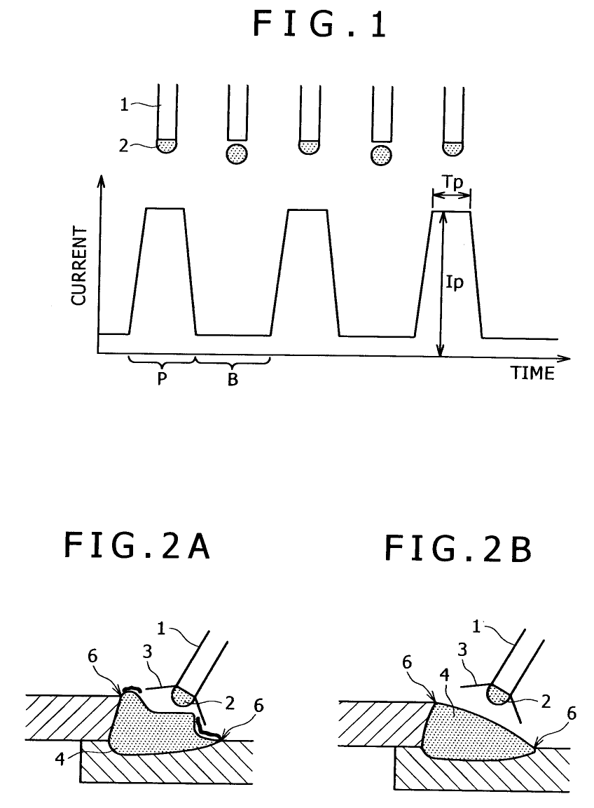

FIG. 1 is a typical view of assistance in explaining the waveform of a pulsating current and a globule transfer mode, FIG. 2A is a typical sectional view of a molten pool (molten metal) formed by welding using a commercial power source, and FIG. 2B is a typical sectional view of a molten pool (molten metal) formed by welding using a pulsating power source of a predetermined pulse waveform.

Pulses

Current pulses and voltage pulses are generated by a pulsating power source and have a rectangular or trapezoidal shape in a repeated manner as shown in FIG. 1. Current pulses shown in FIG. 1 have a trapezoidal shape. Basically, current and voltage pulses have the same shape. When current or voltage increases, base period B decreases and frequency increases. Generally, current or voltage is frequency modulated.

Referring to FIG. 2A, an arc 3 is unstable, spatters increase and a molten pool (molten metal) 4 vibrates intensely when a commercial power source is used. The intense vibration of the molten pool 4 affects adversely to the shape of the toes 6 of a bead. When a pulsating power source that supplies a pulsating current is used, an arc 3 is stable even if the current is low, a few spatters are generated, and a molten pool (molten metal) 4 directly below the arc 3 can be kept in a static state as shown in FIG. 2B. Consequently, the shape of toes 6 of a bead is stabilized.

Effects of the S content of the solid wire and the pulses on the shape of a bead will be described.

The solid wire has the S content mentioned above. The shape of the bead is affected by the S content of the solid wire and the pulses used for pulsation welding.

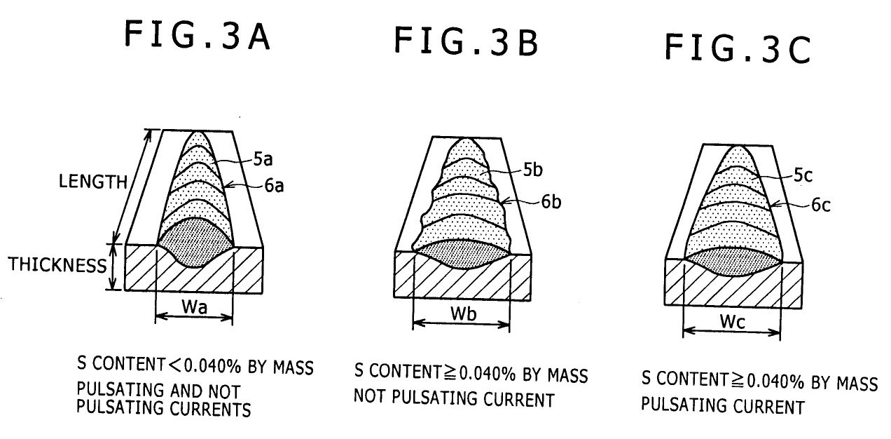

FIGS. 3A, 3B and 3C are typical perspective views of beads formed under different welding conditions specifying solid wires respectively having different S contents and different welding currents, respectively.

FIG. 3A shows a bead 5a formed by using a solid wire having a S content below 0.040% by mass. As obvious from FIG. 3A, although the bead 5a has uniform toes 6a, a molten metal does not spread satisfactorily, and the bead 5a has a narrow width Wa and a convex shape regardless of whether the welding current is a constant current or a pulsating current. FIG. 3B shows a bead 5b formed by using a solid wire having a S content not lower than 0.040% by mass and a constant welding current. As obvious from FIG. 3B, although the bead 5b has a big width Wb and is not convex, the bead 5b has irregular toes 6b. FIG. 3C shows a bead 5c formed by using a solid wire having a S content not lower than 0.04% by mass and a pulsating welding current. As obvious from FIG. 3C, the bead 5c has uniform toes 6c and a sufficiently big width Wc, and is not convex.

The pulsating current has a pulse peak current Iₚ and a pulse peak duration Tₚ meeting conditions specified by the present invention.

The effect of the waveform of a pulsating current on gas-shielded arc welding will be described with reference to FIG. 1.

Referring to FIG. 1, a globule 2 is formed by melting a solid wire 1 in a pulse peak duration Tₚ and the globule 2 drops in a base duration B

The globule 2 is formed by melting the solid wire 1 by supplying a high current supplied in the pulse peak duration Tₚ and the globule 2 drops in the base duration B in which a low current is supplied and the arc is weak. Thus the arc is stable while the welding current is low, the generation of spatters is suppressed, the globule can be steadily transferred, the molten metal directly below the arc is not disturbed, and uniform toes are formed.

As apparent from the foregoing description, the present invention specifies the composition of the solid wire and uses the solid wire for pulsation welding, and specifies the waveform of the pulsating welding current by the pulse peak current Iₚ and the pulse peak duration Tₚ.

Pulse peak current Iₚ: 350 A or above

The pulse peak current Iₚ is the value of the pulsating welding current in the pulse peak duration Tₚ; that is the pulse peak current Iₚ is the height of the rectangular or trapezoidal pulses of the pulsating welding current.

Generally, a user can determine a part of the waveform of a pulsating current. When the pulse peak current Iₚ is below 350, current density is insufficient, spray transfer cannot be achieved, the arc is unstable, many spatters are generated, globule transfer is unstable, the molten metal is disturbed and irregular toes are formed. Although an upper limit to the pulse peak current Iₚ does not need to be determine where globule transfer is concerned, mechanical damage is likely to be caused when the pulse peak current Iₚ is higher than 600 A. Therefore, it is usual to limit the pulse peak current Iₚ to 600 A or below, considering the capacity of the hardware of the welding power source.

Pulse peak duration Tₚ: 0.5 to 2.0 ms

The pulse peak duration Tₚ is a time corresponding to the length of the top side of the rectangular or trapezoidal pulses of the waveform of a pulsating current, in periods P which are other than base periods B in the waveform of the pulsating current. Each of the periods P corresponds to the length of the bottom side of the rectangular or trapezoidal pulse. If the pulses are rectangular, the period P is equal to the pulse peak duration Tₚ.

A pulse peak duration Tₚ below 0.5 ms is not long enough to melt the tip of the wire and to grow a globule, and hence a globule cannot be dropped in the base duration B. Therefore, melting the wire, namely, formation and dropping of a globule, cannot be synchronized with the waveform of the pulsating current. Consequently, the arc becomes unstable, many spatters are generated, the globule cannot be stably transferred, the molten metal is disturbed and irregular toes are formed. When the pulse peak duration Tₚ is above 2.0 ms, the wire is melted, a globule is formed the globule drops, the formation of the next globule is started in the pulse peak duration Tₚ, the pulse peak duration Tₚ terminates before the next globule is formed and the base period B starts. Therefore, melting the wire, namely, formation and dropping of a globule, cannot be synchronized with the waveform of the pulsating current. Consequently, the arc becomes unstable, many spatters are generated, the globule cannot be stably transferred, the molten metal is disturbed and irregular toes are formed. Thus the pulse peak duration Tₚ needs to be between 0.5 and 2.0 ms to ensure the continuation of stable globule transfer.

A shielding gas used by the gas-shielded arc welding method of the present invention will be described.

Shielding gas: Mixed gas containing 75 to 98% by volume Ar and others at least either of CO₂ and O₂

The composition of the shielding gas does not need to be specified strictly, provided that spray transfer is achieved during pulsation welding. Ordinarily, the shielding gas is a mixed oxidizing gas containing 75 to 98% by volume Ar, and other gases including at least CO₂ or O₂ or both CO₂ and O₂. When the Ar concentration of the shielding gas is above 98% by volume, the oxidizing gas concentration of the shielding gas is insufficient, only a very small amount of oxide is formed in the base metal, cathodes of an oxide cannot be formed, the arc becomes very unstable, many spatters are generated, the arc meanders, an irregular bead is formed and irregular toes are formed. Since the molten metal contains a very small amount of the oxide, the surface tension of a molten metal is high, and a bead cannot be formed in a big width and is formed in a convex shape. Therefore, the oxidizing gas concentration of the shielding gas needs to be 2% by volume or above. When the Ar concentration is below 75% by volume, the arc is cooled by an endothermic reaction causing the decomposition of oxidizing gas molecules and the arc cannot achieve spray transfer. Consequently, globules are transferred in an unstable transfer mode in which explosive firing and short-circuit arc quenching are repeated alternately, a molten metal having a low surface tension is disturbed, irregular toes are formed and many spatters are generated.

As apparent from the foregoing description, the generation of spatters can be suppressed, and a wide, flat bead of a satisfactory shape having uniform toes can be formed regardless of welding speed by pulsation welding using the solid wire having the specified composition having a properly high S content and specified by the pulse conditions including Iₚ and Tₚ. Possibility of forming such a wide, flat bead of a satisfactory shape having uniform toes brings about many advantages including the improvement of high-speed weldability, improvement of the fatigue characteristic of joints by moderating stress concentration on weld toes, and widening of the allowable range of displacement of the axis of a weld from a desired weld line.

Thus, it was found that that the shape of the bead can be effectively controlled by using welding materials respectively having specified compositions and a welding current of the specified waveform. This finding is an unprecedented new technical idea.

### EXAMPLES

Gas-shielded arc welding methods in examples of the present invention and those in comparative examples will be comparatively described.

Solid wires of 1.2 mm in diameter having compositions shown in Table 1 to 3 were manufactured by way of experiment. A welding wire in Comparative example 60 is a flux-cored wire. Steel sheets were welded by horizontal lap fillet welding using the solid wires under test conditions specifying shielding gases of predetermined compositions and welding currents of predetermined waveforms.

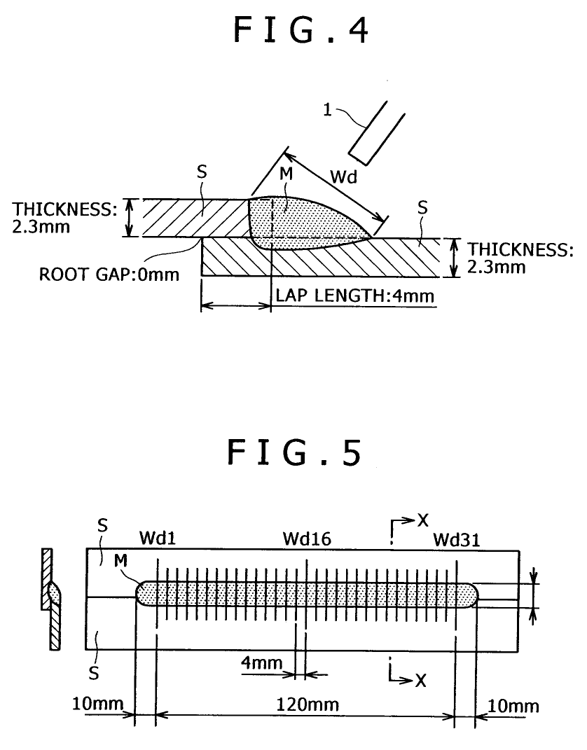

FIG. 4 is a typical sectional view, taken on the line X-X in FIG. 5, of assistance in explaining the relation between the shape of a groove for horizontal lap fillet welding and bead width.

Referring to FIG. 4, ends of 2.3 mm thick hot-rolled steel sheets S were overlapped and welded together by horizontal lap fillet welding to form a bead of 140 mm in weld length (refer to FIG. 5) having a bead width W_{d}. Root gap was 0 mm (no root gap) and lap length was 4 mm. The wires were fed at a fixed wire feed rate for a welding speed. The wire feed rate was adjusted according to the welding speed. Optimum voltages were set, respectively, for the power sources.

The respective widths of beads M were measured and the mean bead width and the standard deviations were calculated. The quality of the beads M was evaluated by sensory inspection in terms of shape, the amount of spatters, cracking resistance and blowholes. Results of evaluation are shown in Tables 4 and 5.

The respective compositions of the solid wires, the respective compositions of the shielding gases used for the tests, and the conditions of the power sources are shown in Tables 1 to 3. In Tables 2 and 3, underlined values are those not meeting conditions required by the present invention.

TABLE 1

| | | Composition of the wire (percent by mass) | | | | | | |
|---|---|---|---|---|---|---|---|---|
| | No. | S | Si | Mn | C | P | Others | Copper plating |
| Examples | 1 | 0.060 | 0.80 | 1.35 | 0.04 | 0.010 | | Plated |
| | 2 | 0.060 | 0.80 | 1.35 | 0.04 | 0.010 | | Not plated |
| | 3 | 0.041 | 0.50 | 1.40 | 0.01 | 0.005 | | Plated |
| | 4 | 0.070 | 0.35 | 1.15 | 0.10 | 0.008 | | Plated |
| | 5 | 0.100 | 1.00 | 1.25 | 0.15 | 0.015 | | Plated |
| | 6 | 0.085 | 1.20 | 1.30 | 0.04 | 0.010 | | Plated |
| | 7 | 0.060 | 0.80 | 1.35 | 0.04 | 0.010 | Ti: 0.08 | Plated |
| | 8 | 0.060 | 0.80 | 1.35 | 0.04 | 0.010 | Nb: 0.25 | Plated |
| | 9 | 0.060 | 0.80 | 1.35 | 0.04 | 0.010 | V: 0.25 | Plated |
| | 10 | 0.050 | 0.50 | 2.00 | 0.06 | 0.018 | Al: 0.18 | Plated |
| | 11 | 0.150 | 0.30 | 1.20 | 0.03 | 0.008 | Mo0.45 | Plated |
| | 12 | 0.065 | 0.20 | 2.50 | 0.03 | 0.012 | | Plated |
| | 13 | 0.050 | 0.70 | 1.00 | 0.06 | 0.010 | | Plated |
| | 14 | 0.070 | 0.90 | 1.30 | 0.04 | 0.015 | | Not plated |
| | 15 | 0.090 | 0.80 | 1.50 | 0.05 | 0.008 | Nb: 0.02 | Not plated |
| | 16 | 0.060 | 0.80 | 1.35 | 0.04 | 0.010 | | Plated |
| | 17 | 0.060 | 0.80 | 1.35 | 0.04 | 0.010 | | Plated |
| | 18 | 0.060 | 0.80 | 1.35 | 0.04 | 0.010 | | Plated |
| | 19 | 0.048 | 0.50 | 1.40 | 0.02 | 0.005 | | Not plated |
| | 20 | 0.195 | 1.50 | 0.55 | 0.06 | 0.023 | Nb0.03, V: 0.05, Al: 0.01, Mo: 0.05 | Plated |
| | 21 | 0.060 | 0.80 | 1.35 | 0.04 | 0.010 | | Plated |
| | 22 | 0.060 | 0.80 | 1.35 | 0.04 | 0.010 | | Plated |
| | 23 | 0.060 | 0.80 | 1.35 | 0.04 | 0.010 | | Plated |
| | 24 | 0.060 | 0.80 | 1.35 | 0.04 | 0.010 | Cr: 1.00 | Plated |
| | 25 | 0.060 | 0.80 | 1.35 | 0.04 | 0.010 | Ni: 1.00 | Plated |

| | | | | | | Welding | Wire |
|---|---|---|---|---|---|---|---|
| | | Composition of Shielding | Power Source | | | speed | feed rate |
| | No. | gas (percent by volume) | Type of current | Ip (A) | Tp (msec) | (cm/min) | (m/min) |
| Examples | 1 | Ar80% + CO₂20% | Pulsating | 460 | 1.2 | 100 | 5.0 |
| | 2 | Ar80% + CO₂20% | Pulsating | 460 | 1.2 | 100 | 5.0 |
| | 3 | Ar80% + CO₂20% | Pulsating | 480 | 1.1 | 100 | 5.0 |
| | 4 | Ar80% + CO₂20% | Pulsating | 520 | 0.8 | 100 | 5.0 |
| | 5 | Ar80% + CO₂20% | Pulsating | 420 | 1.0 | 100 | 5.0 |
| | 6 | Ar80% + CO₂20% | Pulsating | 420 | 1.5 | 100 | 5.0 |
| | 7 | Ar80% + CO₂20% | Pulsating | 400 | 1.8 | 100 | 5.0 |
| | 8 | Ar80% + CO₂20% | Pulsating | 460 | 0.5 | 100 | 5.0 |
| | 9 | Ar80% + CO₂20% | Pulsating | 460 | 0.8 | 100 | 5.0 |
| | 10 | Ar80% + CO₂20% | Pulsating | 500 | 0.8 | 100 | 5.0 |
| | 11 | Ar80% + CO₂20% | Pulsating | 500 | 1.1 | 100 | 5.0 |
| | 12 | Ar80% + CO₂20% | Pulsating | 500 | 1.4 | 100 | 5.0 |
| | 13 | Ar80% + CO₂20% | Pulsating | 420 | 0.6 | 100 | 5.0 |
| | 14 | Ar80% + CO₂20% | Pulsating | 460 | 1.6 | 100 | 5.0 |
| | 15 | Ar80% + CO₂20% | Pulsating | 520 | 1.2 | 100 | 5.0 |
| | 16 | Ar75% + CO₂21% + O₂4% | Pulsating | 460 | 1.2 | 100 | 5.0 |
| | 17 | Ar90% + CO₂10% | Pulsating | 460 | 1.2 | 100 | 5.0 |
| | 18 | Ar98% + O₂2% | Pulsating | 460 | 1.0 | 100 | 5.0 |
| | 19 | Ar80% + CO₂10% + | Pulsating | 460 | 1.2 | 100 | 5.0 |
| | | O₂10% | | | | | |
| | 20 | Ar80% + CO₂20% | Pulsating | 590 | 1.0 | 100 | 5.0 |
| | 21 | Ar80% + CO₂20% | Pulsating | 350 | 2.0 | 100 | 5.0 |
| | 22 | Ar80% + CO₂20% | Pulsating | 580 | 1.2 | 50 | 2.5 |
| | 23 | Ar80% + CO₂20% | Pulsating | 460 | 1.2 | 140 | 7.0 |
| | 24 | Ar80% + CO₂20% | Pulsating | 460 | 1.2 | 100 | 5.0 |
| | 25 | Ar80% + CO₂20% | Pulsating | 460 | 1.2 | 100 | 5.0 |

TABLE 2

| | | Composition of the wire (percent by mass) | | | | | | | Composition of Shielding |
|---|---|---|---|---|---|---|---|---|---|
| | No. | S | Si | Mn | C | P | Others | Copper plating | gas (percent by volume) |
| Comparative | 26 | 0.004 | 1.10 | 1.20 | 0.09 | 0.010 | | Plated | Ar80% + CO₂20% |
| examples | 27 | 0.010 | 0.80 | 1.35 | 0.04 | 0.010 | | Plated | Ar80% + CO₂20% |
| | 28 | 0.020 | 0.90 | 1.45 | 0.07 | 0.012 | | Plated | Ar80% + CO₂20% |
| | 29 | 0.030 | 0.60 | 1.25 | 0.06 | 0.007 | | Plated | Ar80% + CO₂20% |
| | 30 | 0.038 | 0.40 | 1.25 | 0.06 | 0.008 | | Not plated | Ar80% + CO₂20% |
| | 31 | 0.036 | 0.80 | 1.35 | 0.04 | 0.010 | | Plated | Ar80% + CO₂20% |
| | 32 | 0.060 | 0.80 | 1.35 | 0.04 | 0.010 | | Plated | Ar80% + CO₂20% |
| | 33 | 0.070 | 0.35 | 1.15 | 0.07 | 0.008 | | Plated | Ar80% + CO₂20% |
| | 34 | 0.100 | 1.00 | 1.25 | 0.10 | 0.015 | | Not plated | Ar80% + CO₂20% |
| | 35 | 0.150 | 0.60 | 1.70 | 0.05 | 0.010 | | Plated | Ar80% + CO₂20% |
| | 36 | 0.050 | 0.80 | 1.35 | 0.08 | 0.025 | | Plated | Ar75% + CO₂21% + O₂4% |
| | 37 | 0.080 | 0.80 | 1.50 | 0.03 | 0.007 | Ti: 0.05 | Plated | Ar90% + CO₂10% |
| | 38 | 0.060 | 0.80 | 1.35 | 0.04 | 0.010 | Nb: 0.10 | Plated | Ar95% + O₂5% |
| | 39 | 0.050 | 0.50 | 1.50 | 0.06 | 0.018 | Al: 0.05 | Plated | Ar80% + CO₂10% + O₂10% |
| | 40 | 0.060 | 0.80 | 1.35 | 0.04 | 0.010 | | Not Plated | Ar80% + CO₂20% |
| | 41 | 0.025 | 0.85 | 1.25 | 0.03 | 0.010 | | Plated | Ar80% + CO₂20% |
| | 42 | 0.060 | 0.80 | 1.35 | 0.04 | 0.010 | | Plated | Ar80% + CO₂20% |
| | 43 | 0.080 | 0.90 | 1.30 | 0.06 | 0.010 | | Plated | Ar80% + CO₂20% |
| | 44 | 0.045 | 0.55 | 1.55 | 0.03 | 0.015 | | Plated | Ar80% + CO₂20% |
| | 45 | 0.060 | 0.80 | 1.35 | 0.04 | 0.010 | | Plated | Ar80% + CO₂20% |
| | 46 | 0.210 | 0.80 | 1.40 | 0.03 | 0.005 | | Plated | Ar80% + CO₂20% |
| | 47 | 0.060 | 0.80 | 1.35 | 0.16 | 0.010 | | Plated | Ar80% + CO₂20% |
| | 48 | 0.060 | 0.15 | 1.35 | 0.06 | 0.010 | | Plated | Ar80% + CO₂20% |
| | 49 | 0.060 | 1.60 | 1.35 | 0.06 | 0.010 | | Plated | Ar80% + CO₂20% |

| | | | | | Welding | |
|---|---|---|---|---|---|---|
| | | Power Source | | | speed | Wire feed rate |
| | No. | Type of current | Ip (A) | Tp (msec) | (cm/min) | (m/min) |
| Comparative | 26 | Pulsating | 460 | 1.2 | 100 | 5.0 |
| examples | 27 | Pulsating | 460 | 1.2 | 100 | 5.0 |
| | 28 | Pulsating | 460 | 1.2 | 100 | 5.0 |
| | 29 | Pulsating | 460 | 1.2 | 100 | 5.0 |
| | 30 | Pulsating | 460 | 1.2 | 100 | 5.0 |
| | 31 | Pulsating | 460 | 1.2 | 100 | 5.0 |
| | 32 | Not pulsating | — | — | 100 | 5.0 |
| | 33 | Not pulsating | — | — | 100 | 5.0 |
| | 34 | Not pulsating | — | — | 100 | 5.0 |
| | 35 | Not pulsating | — | — | 100 | 5.0 |
| | 36 | Not pulsating | — | — | 100 | 5.0 |
| | 37 | Not pulsating | — | — | 100 | 5.0 |
| | 38 | Not pulsating | — | — | 100 | 5.0 |
| | 39 | Not pulsating | — | — | 100 | 5.0 |
| | 40 | Not pulsating | — | — | 100 | 5.0 |
| | 41 | Not pulsating | — | — | 100 | 5.0 |
| | 42 | Pulsating | 340 | 1.6 | 100 | 5.0 |
| | 43 | Pulsating | 540 | 0.3 | 100 | 5.0 |
| | 44 | Pulsating | 390 | 2.1 | 100 | 5.0 |
| | 45 | Pulsating | 460 | 3.0 | 100 | 5.0 |
| | 46 | Pulsating | 460 | 1.2 | 100 | 5.0 |
| | 47 | Pulsating | 460 | 1.2 | 100 | 5.0 |
| | 48 | Pulsating | 460 | 1.2 | 100 | 5.0 |
| | 49 | Pulsating | 460 | 1.2 | 100 | 5.0 |

TABLE 3

| | | Composition of the wire (percent by mass) | | | | | | |
|---|---|---|---|---|---|---|---|---|
| | No. | S | Si | Mn | C | P | Others | Copper plating |
| Comparative | 50 | 0.060 | 0.80 | 0.40 | 0.06 | 0.010 | | Plated |
| examples | 51 | 0.060 | 0.80 | 2.60 | 0.06 | 0.010 | | Plated |
| | 52 | 0.060 | 0.80 | 1.35 | 0.06 | 0.027 | | Plated |
| | 53 | 0.060 | 0.80 | 1.35 | 0.06 | 0.010 | Ti: 0.12 | Plated |
| | 54 | 0.060 | 0.80 | 1.35 | 0.06 | 0.010 | Al: 0.25 | Plated |
| | 55 | 0.060 | 0.80 | 1.35 | 0.06 | 0.010 | Mo: 0.55 | Plated |
| | 56 | 0.060 | 0.80 | 1.35 | 0.06 | 0.010 | Nb: 0.35 | Plated |
| | 57 | 0.060 | 0.80 | 1.35 | 0.06 | 0.010 | V: 0.35 | Plated |
| | 58 | 0.060 | 0.80 | 1.35 | 0.06 | 0.010 | Cr: 1.10 | Plated |
| | 59 | 0.060 | 0.80 | 1.35 | 0.06 | 0.010 | Ni: 1.10 | Plated |
| | 60 | 0.060 | 0.80 | 1.35 | 0.06 | 0.010 | Flux-cored wire | Not plated |
| | 61 | 0.060 | 0.80 | 1.35 | 0.06 | 0.010 | | Plated |
| | 62 | 0.060 | 0.80 | 1.35 | 0.06 | 0.010 | | Plated |
| | 63 | 0.060 | 0.80 | 1.35 | 0.06 | 0.010 | | Plated |
| | 64 | 0.080 | 0.80 | 1.50 | 0.03 | 0.007 | Mo: 0.10 | Plated |
| | 65 | 0.060 | 0.80 | 1.35 | 0.04 | 0.010 | Ti: 0.10, Nb: 0.10, Ni: 0.10 | Plated |
| | 66 | 0.080 | 0.90 | 1.36 | 0.06 | 0.010 | Al: 0.20 | Plated |
| | 67 | 0.045 | 0.55 | 1.55 | 0.03 | 0.015 | Cr: 0.80, Ni: 0.70 | Plated |
| | 68 | 0.060 | 0.80 | 1.35 | 0.06 | 0.010 | Ti: 0.02, Mo: 0.02, V: 0.02 | Plated |
| | 69 | 0.060 | 0.80 | 1.35 | 0.06 | 0.010 | Ti: 0.02, Mo: 0.02, V: 0.02 | Plated |
| | 70 | 0.060 | 0.80 | 1.35 | 0.06 | 0.010 | Cr: 0.02, Ti: 0.01 | Plated |

| | | | | | | | Wire |
|---|---|---|---|---|---|---|---|
| | | | Power Source | | | Welding | feed |
| | | Composition of Shielding | Type of | | | speed | rate |
| | No. | gas (percent by volume) | current | Ip (A) | Tp (msec) | (cm/min) | (m/min) |
| Comparative | 50 | Ar80% + CO₂20% | Pulsating | 460 | 1.2 | 100 | 5.0 |
| examples | 51 | Ar80% + CO₂20% | Pulsating | 460 | 1.2 | 100 | 5.0 |
| | 52 | Ar80% + CO₂20% | Pulsating | 460 | 1.2 | 100 | 5.0 |
| | 53 | Ar80% + CO₂20% | Pulsating | 460 | 1.2 | 100 | 5.0 |
| | 54 | Ar80% + CO₂20% | Pulsating | 460 | 1.2 | 100 | 5.0 |
| | 55 | Ar80% + CO₂20% | Pulsating | 460 | 1.2 | 100 | 5.0 |
| | 56 | Ar80% + CO₂20% | Pulsating | 460 | 1.2 | 100 | 5.0 |
| | 57 | Ar80% + CO₂20% | Pulsating | 460 | 1.2 | 100 | 5.0 |
| | 58 | Ar80% + CO₂20% | Pulsating | 460 | 1.2 | 100 | 5.0 |
| | 59 | Ar80% + CO₂20% | Pulsating | 460 | 1.2 | 100 | 5.0 |
| | 60 | Ar80% + CO₂20% | Pulsating | 460 | 1.2 | 100 | 5.0 |
| | 61 | Ar73% + CO₂27% | Pulsating | 460 | 1.2 | 100 | 5.0 |
| | 62 | Ar70% + CO₂25% + | Pulsating | 460 | 1.2 | 100 | 5.0 |
| | | O₂5% | | | | | |
| | 63 | Ar100% | Pulsating | 460 | 1.2 | 100 | 5.0 |
| | 64 | Ar80% + CO₂20% | Not | — | — | 100 | 5.0 |
| | | | Pulsating | | | | |
| | 65 | Ar80% + CO₂20% | Pulsating | 330 | 1.6 | 100 | 5.0 |
| | 66 | Ar80% + CO₂20% | Pulsating | 540 | 0.4 | 100 | 5.0 |
| | 67 | Ar80% + CO₂20% | Pulsating | 390 | 2.5 | 100 | 5.0 |
| | 68 | Ar73% + CO₂27% | Pulsating | 460 | 1.2 | 100 | 5.0 |
| | 69 | Ar99% + O₂1% | Pulsating | 460 | 1.2 | 100 | 5.0 |
| | 70 | Ar70% + CO₂25% + | Not | — | — | 100 | 5.0 |
| | | O₂5% | Pulsating | | | | |

Shape of Bead

The shape of a bead was evaluated in terms of mean bead width, standard deviation and flatness.

Mean Bead Width

FIG. 5 is a typical view of assistance in explaining a method of determining the width of a bead formed by horizontal lap fillet welding.

As shown in FIG. 5, a sample bead of 120 mm in length was determined by removing opposite end parts of 10 mm in length from a bead of 140 mm in weld length. Thirty-one measuring parts were specified on the sample bead at intervals of 4 mm and widths W_{d1} to W_{d31} of the thirty-one measuring parts of the sample bead were measured. The mean of the thirty-one widths W_{d1} to W_{d31} was calculated to obtain a mean width of the sample bead. The beads having a mean width of 6.0 mm were graded acceptable (marked with a blank circle), and those having a mean width below 6 mm were graded unacceptable (marked with a cross).

Standard Deviation

The standard deviation obtained by statistically processing the measured bead widths W_{d1} to W_{d31} was used as an index the uniformity of toes. Toes were graded acceptable (marked with a blank circle) when the standard deviation was 0.50 or below, and toes were graded unacceptable (marked with a cross) when the standard deviation was above 0.50.

Flatness

Flatness was evaluated through the visual observation of the bead. The beads looked not convex were graded acceptable (marked with a circle) and those looked convex were graded unacceptable (marked with a cross).

Spatters

All the spatters generated during welding were collected, and the number of spatters generated per 1 min was calculated to obtain a spattering rate. A spattering rate not greater than 1.50 g/min was graded acceptable (marked with a blank circle) and a spattering rate above 1.50 g/min was graded unacceptable (marked with a cross).

Cracking Resistance

A reinforcement of weld was removed from the bead and the bead was examined for cracks. The bead in which any cracks were not found was graded acceptable (marked with a blank circle) and a bead in which cracks were found was graded unacceptable (marked with a cross).

Other Qualities

Beads not having blowholes and not coated with an excessive amount of slag were graded acceptable (marked with a blank circle) and those having blowholes and coated with an excessive amount of slag were graded unacceptable (marked with a cross).

Overall Judgment

The beads represented by measurements all of which were graded acceptable (blank circle) were graded acceptable (marked with a blank circle) and those represented by measurements including even one measurement graded unacceptable (cross) were graded unacceptable (marked with a cross).

TABLE 4

| | | Shape of Bead | | | | | | | | | | | | |
|---|---|---|---|---|---|---|---|---|---|---|---|---|---|---|
| | | Mean bead | | Standard | | | | Spattering | | Resistance | | | | |
| | | width | | deviation | | Flatness | | rate | | to cracking | | Blowholes | | Overall |
| | No. | mm | Rating | | Rating | Shape | Rating | g/min | Rating | Cracks | Rating | | Rating | Judgment |
| Examples | 1 | 6.8 | ◯ | 0.35 | ◯ | Not convex | ◯ | 0.75 | ◯ | Not cracked | ◯ | None | ◯ | ◯ |
| | 2 | 6.8 | ◯ | 0.35 | ◯ | Not convex | ◯ | 0.65 | ◯ | Not cracked | ◯ | None | ◯ | ◯ |
| | 3 | 6.1 | ◯ | 0.25 | ◯ | Not convex | ◯ | 0.78 | ◯ | Not cracked | ◯ | None | ◯ | ◯ |
| | 4 | 6.9 | ◯ | 0.37 | ◯ | Not convex | ◯ | 0.79 | ◯ | Not cracked | ◯ | None | ◯ | ◯ |
| | 5 | 7.1 | ◯ | 0.44 | ◯ | Not convex | ◯ | 0.88 | ◯ | Not cracked | ◯ | None | ◯ | ◯ |
| | 6 | 7.0 | ◯ | 0.38 | ◯ | Not convex | ◯ | 0.95 | ◯ | Not cracked | ◯ | None | ◯ | ◯ |
| | 7 | 6.6 | ◯ | 0.33 | ◯ | Not convex | ◯ | 1.02 | ◯ | Not cracked | ◯ | None | ◯ | ◯ |
| | 8 | 6.5 | ◯ | 0.33 | ◯ | Not convex | ◯ | 0.74 | ◯ | Not cracked | ◯ | None | ◯ | ◯ |
| | 9 | 6.5 | ◯ | 0.32 | ◯ | Not convex | ◯ | 0.89 | ◯ | Not cracked | ◯ | None | ◯ | ◯ |
| | 10 | 6.6 | ◯ | 0.32 | ◯ | Not convex | ◯ | 1.20 | ◯ | Not cracked | ◯ | None | ◯ | ◯ |
| | 11 | 7.3 | ◯ | 0.33 | ◯ | Not convex | ◯ | 1.10 | ◯ | Not cracked | ◯ | None | ◯ | ◯ |
| | 12 | 6.8 | ◯ | 0.37 | ◯ | Not convex | ◯ | 1.21 | ◯ | Not cracked | ◯ | None | ◯ | ◯ |
| | 13 | 6.5 | ◯ | 0.28 | ◯ | Not convex | ◯ | 0.88 | ◯ | Not cracked | ◯ | None | ◯ | ◯ |
| | 14 | 6.6 | ◯ | 0.36 | ◯ | Not convex | ◯ | 0.95 | ◯ | Not cracked | ◯ | None | ◯ | ◯ |
| | 15 | 6.9 | ◯ | 0.39 | ◯ | Not convex | ◯ | 0.75 | ◯ | Not cracked | ◯ | None | ◯ | ◯ |
| | 16 | 6.9 | ◯ | 0.35 | ◯ | Not convex | ◯ | 1.35 | ◯ | Not cracked | ◯ | None | ◯ | ◯ |
| | 17 | 6.7 | ◯ | 0.35 | ◯ | Not convex | ◯ | 0.55 | ◯ | Not cracked | ◯ | None | ◯ | ◯ |
| | 18 | 6.7 | ◯ | 0.36 | ◯ | Not convex | ◯ | 0.38 | ◯ | Not cracked | ◯ | None | ◯ | ◯ |
| | 19 | 6.3 | ◯ | 0.30 | ◯ | Not convex | ◯ | 1.10 | ◯ | Not cracked | ◯ | None | ◯ | ◯ |
| | 20 | 7.5 | ◯ | 0.45 | ◯ | Not convex | ◯ | 0.77 | ◯ | Not cracked | ◯ | None | ◯ | ◯ |
| | 21 | 6.8 | ◯ | 0.35 | ◯ | Not convex | ◯ | 0.65 | ◯ | Not cracked | ◯ | None | ◯ | ◯ |
| | 22 | 7.2 | ◯ | 0.38 | ◯ | Not convex | ◯ | 1.25 | ◯ | Not cracked | ◯ | None | ◯ | ◯ |
| | 23 | 6.3 | ◯ | 0.40 | ◯ | Not convex | ◯ | 0.50 | ◯ | Not cracked | ◯ | None | ◯ | ◯ |
| | 24 | 6.2 | ◯ | 0.38 | ◯ | Not convex | ◯ | 1.21 | ◯ | Not cracked | ◯ | None | ◯ | ◯ |
| | 25 | 6.2 | ◯ | 0.38 | ◯ | Not convex | ◯ | 1.23 | ◯ | Not cracked | ◯ | None | ◯ | ◯ |

TABLE 5

| | | Shape of Bead | | | | | | | | | | | | |
|---|---|---|---|---|---|---|---|---|---|---|---|---|---|---|
| | | Mean bead | | Standard | | | | Spattering | | Resistance | | | | |
| | | width | | deviation | | Flatness | | rate | | to cracking | | Blowholes | | Overall |
| | No. | mm | Rating | | Rating | Shape | Rating | g/min | Rating | Cracks | Rating | | Rating | Judgment |
| Comparative | 26 | 4.2 | X | 0.34 | ◯ | Convex | X | 0.95 | ◯ | Not cracked | ◯ | None | ◯ | X |
| examples | 27 | 4.4 | X | 0.35 | ◯ | Convex | X | 1.01 | ◯ | Not cracked | ◯ | None | ◯ | X |
| | 28 | 4.8 | X | 0.39 | ◯ | Convex | X | 1.00 | ◯ | Not cracked | ◯ | None | ◯ | X |
| | 29 | 5.0 | X | 0.40 | ◯ | Convex | X | 0.78 | ◯ | Not cracked | ◯ | None | ◯ | X |
| | 30 | 5.8 | X | 0.46 | ◯ | Convex | X | 0.85 | ◯ | Not cracked | ◯ | None | ◯ | X |
| | 31 | 5.5 | X | 0.44 | ◯ | Convex | X | 0.90 | ◯ | Not cracked | ◯ | None | ◯ | X |
| | 32 | 6.5 | ◯ | 0.85 | X | Not convex | ◯ | 1.95 | X | Not cracked | ◯ | None | ◯ | X |
| | 33 | 6.6 | ◯ | 0.89 | X | Not convex | ◯ | 2.05 | X | Not cracked | ◯ | None | ◯ | X |
| | 34 | 6.8 | ◯ | 1.05 | X | Not convex | ◯ | 1.78 | X | Not cracked | ◯ | None | ◯ | X |
| | 35 | 6.9 | ◯ | 1.18 | X | Not convex | ◯ | 1.86 | X | Not cracked | ◯ | None | ◯ | X |
| | 36 | 6.1 | ◯ | 0.75 | X | Not convex | ◯ | 2.02 | X | Not cracked | ◯ | None | ◯ | X |
| | 37 | 6.5 | ◯ | 0.90 | X | Not convex | ◯ | 1.60 | X | Not cracked | ◯ | None | ◯ | X |
| | 38 | 6.5 | ◯ | 0.77 | X | Not convex | ◯ | 1.53 | X | Not cracked | ◯ | None | ◯ | X |
| | 39 | 6.1 | ◯ | 0.72 | X | Not convex | ◯ | 2.10 | X | Not cracked | ◯ | None | ◯ | X |
| | 40 | 6.5 | ◯ | 0.85 | X | Not convex | ◯ | 1.99 | X | Not cracked | ◯ | None | ◯ | X |
| | 41 | 4.5 | X | 0.35 | ◯ | Convex | X | 1.80 | X | Not cracked | ◯ | None | ◯ | X |
| | 42 | 6.7 | ◯ | 0.75 | X | Not convex | ◯ | 1.75 | X | Not cracked | ◯ | None | ◯ | X |
| | 43 | 7.0 | ◯ | 0.90 | X | Not convex | ◯ | 1.90 | X | Not cracked | ◯ | None | ◯ | X |
| | 44 | 6.1 | ◯ | 0.95 | X | Not convex | ◯ | 1.65 | X | Not cracked | ◯ | None | ◯ | X |
| | 45 | 6.8 | ◯ | 1.15 | X | Not convex | ◯ | 1.81 | X | Not cracked | ◯ | None | ◯ | X |
| | 46 | 7.4 | ◯ | 0.38 | ◯ | Not convex | ◯ | 1.35 | ◯ | Cracked | X | None | ◯ | X |
| | 47 | 6.2 | ◯ | 0.40 | ◯ | Not convex | ◯ | 1.45 | ◯ | Cracked | X | None | ◯ | X |
| | 48 | 7.4 | ◯ | 0.47 | ◯ | Not convex | ◯ | 1.25 | ◯ | Not cracked | ◯ | Some | X | X |
| | 49 | 5.7 | X | 0.33 | ◯ | Convex | X | 1.20 | ◯ | Not cracked | ◯ | None | ◯ | X |
| | 50 | 7.1 | ◯ | 0.46 | ◯ | Not convex | ◯ | 1.35 | ◯ | Not cracked | ◯ | Some | X | X |
| | 51 | 5.6 | X | 0.32 | ◯ | Convex | X | 1.24 | ◯ | Not cracked | ◯ | None | ◯ | X |
| | 52 | 6.9 | ◯ | 0.35 | ◯ | Not convex | ◯ | 0.89 | ◯ | Cracked | X | None | ◯ | X |
| | 53 | 5.5 | X | 0.37 | ◯ | Convex | X | 1.25 | ◯ | Not cracked | ◯ | None | ◯ | X |
| | 54 | 5.6 | X | 0.38 | ◯ | Convex | X | 1.38 | ◯ | Not cracked | ◯ | None | ◯ | X |
| | 55 | 5.4 | X | 0.36 | ◯ | Convex | X | 1.10 | ◯ | Not cracked | ◯ | None | ◯ | X |
| | 56 | 5.5 | X | 0.31 | ◯ | Convex | X | 1.05 | ◯ | Not cracked | ◯ | None | ◯ | X |
| | 57 | 5.7 | X | 0.39 | ◯ | Convex | X | 1.43 | ◯ | Not cracked | ◯ | None | ◯ | X |
| | 58 | 5.4 | X | 0.36 | ◯ | Convex | X | 1.00 | ◯ | Not cracked | ◯ | None | ◯ | X |
| | 59 | 5.7 | X | 0.34 | ◯ | Convex | X | 1.12 | ◯ | Not cracked | ◯ | None | ◯ | X |
| | 60 | 6.8 | ◯ | 0.87 | X | Not convex | ◯ | 2.02 | X | Not cracked | ◯ | None | ◯ | X |
| | 61 | 6.5 | ◯ | 1.10 | X | Not convex | ◯ | 2.33 | X | Not cracked | ◯ | None | ◯ | X |
| | 62 | 7.0 | ◯ | 1.15 | X | Not convex | ◯ | 2.45 | X | Not cracked | ◯ | None | ◯ | X |
| | 63 | 3.8 | X | 2.20 | X | Convex | X | 1.95 | X | Not cracked | ◯ | None | ◯ | X |
| | 64 | 6.3 | ◯ | 0.90 | X | Not convex | ◯ | 1.69 | X | Not cracked | ◯ | None | ◯ | X |
| | 65 | 6.8 | ◯ | 0.77 | X | Not convex | ◯ | 1.85 | X | Not cracked | ◯ | None | ◯ | X |
| | 66 | 7.1 | ◯ | 0.91 | X | Not convex | ◯ | 1.86 | X | Not cracked | ◯ | None | ◯ | X |
| | 67 | 6.3 | ◯ | 0.98 | X | Not convex | ◯ | 1.69 | X | Not cracked | ◯ | None | ◯ | X |
| | 68 | 6.6 | ◯ | 1.12 | X | Not convex | ◯ | 2.39 | X | Not cracked | ◯ | None | ◯ | X |
| | 69 | 4.1 | X | 1.93 | X | Convex | X | 1.75 | X | Not cracked | ◯ | None | ◯ | X |
| | 70 | 6.8 | ◯ | 1.22 | X | Not convex | ◯ | 2.85 | X | Not cracked | ◯ | None | ◯ | X |

As obvious from Table 4, all the beads in Examples Nos. 1 to 25 were acceptable (blank circle). The respective compositions of the wires and the shielding gases used for forming the beads in Examples Nos. 1 to 25 met the requirements of the present invention. The pulse peak currents Iₚ and the pulse peak durations Tₚ used for pulsation welding to form the beads in Examples Nos. 1 to 25 met the conditions specified by the present invention. The beads in Examples Nos. 1 to 25 were excellent in shape (mean bead width, standard deviation and flatness), the amount of spatters, cracking resistance and all other respects.

As obvious from table 5, the wires used for forming the beads in Comparative examples Nos. 26 to 31 had a S content below the lower limit of the S content range specified by the present invention. Although satisfactory in the uniformity of toes, the beads in Comparative examples 26 to 31 were narrow and convex. The respective compositions of the wires used for forming the beads in Comparative examples Nos. 32 to 40 met the composition specified by the present invention formed molten metals having a satisfactorily low surface tension to form those beads in a wide, flat shape. Currents supplied by the power sources used for forming the beads in Comparative examples 26 to 31 were not pulsating currents. Therefore, many spatters were generated. Globule transfer was unstable, the molten metal was disturbed and irregular toes were formed. Since the bead thus had an irregular width, the standard deviation was large.

The solid wire formed the beads in Comparative example No. 41 had a S contact below the specified lower limit, and the power source supplied a current which was not pulsating. Although the toes were uniform, many spatters were generated and the bead was narrow and convex. The power source used for forming the bead in Comparative example No. 42 supplied a pulsating current. However, the pulse peak current Iₚ of the pulsating current was below the specified lower limit. Consequently, stable spray transfer could not be achieved, the arc was unstable, many spatters were generated, the molten metal was disturbed by unstable globule transfer, and irregular toes were formed.

The power source used for forming the bead in Comparative example No. 43 supplied a pulsating current. However, the pulse peak duration Tₚ was below the specified lower limit, the globules could not be formed in the pulse peak duration Tₚ, and the formation and dropping of the globule were not synchronized with the waveform of the pulsating current. Consequently, the arc was unstable, many spatters were generated, the molten metal was disturbed by unstable globule transfer, and irregular toes were formed.

The power source used for forming the bead in Comparative example Nos. 44 and 45 supplied a pulsating current. However, the pulse peak duration Tₚ was above the specified upper limit, the globules dropped naturally in the pulse peak duration Tₚ, the base period B started while the next globule was being formed, and the formation and dropping of the globule were not synchronized with the waveform of the pulsating current. Consequently, the arc was unstable, many spatters were generated, the molten metal was disturbed by unstable globule transfer, and irregular toes were formed. The solid wire used for forming the bead in Comparative example No. 46 had a S content above the specified upper limit. Cracks were formed in the bead.

The solid wire used for forming the bead in Comparative example No. 47 had an excessively high C content and cracks were formed in the bead. The solid wire used for forming the bead in Comparative example No. 48 had an excessively low Si content, deoxidation was insufficient and blowholes were formed in the bead. The solid wire used for forming the bead in Comparative example No. 49 had an excessively high Si content, the surface tension of the molten metal was high. Although the bead had uniform toes, the bead was narrow and convex. The solid wire used for forming the bead in Comparative example No. 50 had an excessively low Mn content, deoxidation was insufficient and blowholes were formed in the bead. The solid wire used for forming the bead in Comparative example No. 51 had an excessively high Mn content, and the surface tension of the molten metal was high. Although the bead had uniform toes, the bead was narrow and convex. The solid wire used for forming the bead in Comparative example No. 52 had an excessively high P content and cracks were formed in the bead.

The solid wires used for forming the beads in Comparative examples Nos. 53 to 59 contained Ti, Al, Mo, Nb, V, Cr and Ni excessively, the surface tensions of the molten metals were high. Although the beads had uniform toes, the beads were narrow and convex. A flux-cored wire formed by wrapping a flux with a steel band was used for forming the bead in Comparative example No. 60. Although the flux-cored wire component contents within specified ranges, globules formed by the flux-cored wire separated from the flux-cored wire irregularly and dropped asynchronously with the waveform of the pulsating current, the arc was unstable, many spatters were generated and irregular toes were formed.

The shielding gas used for forming the beads in Comparative example Nos. 61 and 62 had an Ar concentration below the specified lower limit. The arc was unstable, many spatters were generated and irregular toes were formed. The shielding gas used for forming the bead in Comparative example No. 63 had an Ar concentration above the specified upper limit. The shielding gas had an insufficient oxidizing gas concentration, only a little oxide was produced in the base metal, the arc was unstable, many spatters were generated and irregular toes were formed. Since the molten metal contained a very small amount of oxygen, the bead was narrow and convex.

The composition of the wire used for forming the bead in Comparative example No. 64 met the specified composition, the surface tension of the molten meal was reduced satisfactorily, and the bead was wide and flat. However, since the power source supplied an ordinary current which was not pulsating, many spatters were generated, globule transfer was unstable, the molten metal was disturbed, and irregular toes were formed. A pulsating current used for forming the bead in Comparative example No. 65 had a pulse peak current Iₚ below the specified lower limit. Consequently, stable spray transfer could not be achieved, the arc was unstable, many spatters were generated, globule transfer was unstable, the molten metal was disturbed and irregular toes were formed.

A pulsating current used for forming the bead in Comparative example No. 66 had a pulse peak duration Tₚ below the specified lower limit. Consequently, the globules could not be formed in the pulse peak duration Tₚ, and the formation and dropping of the globule were not synchronized with the waveform of the pulsating current. Consequently, the arc was unstable, many spatters were generated, the molten metal was disturbed by unstable globule transfer, and irregular toes were formed. A pulsating current used for forming the bead in Comparative example No. 67 had a pulse peak duration Tₚ above the specified upper limit. Consequently, a globule formed in the pulse peak duration Tₚ dropped naturally, the base period B started while the next globule was being formed, and the formation and dropping of the globule were not synchronized with the waveform of the pulsating current. Consequently, the arc was unstable, many spatters were generated, the molten metal was disturbed by unstable globule transfer, and irregular toes were formed.

The shielding gas used for forming the bead in Comparative example No. 68 had an Ar concentration below the specified lower limit. Consequently, the arc was unstable, many spatters were generated and irregular toes were formed. The shielding gas used for forming the bead in Comparative example No. 69 had an Ar concentration above the specified upper limit and an insufficient oxidizing gas concentration. Consequently, a little oxide was produced in the base metal, the arc was unstable, many spatters were generated and irregular toes were formed. Since the molten metal contained a very little amount of oxygen, the bead was narrow and convex. The shielding gas used for forming the bead in Comparative example No. 70 had an Ar concentration below the specified lower limit. The power source used for forming the bead in Comparative example No. 70 supplied an ordinary current which was not pulsating. Consequently, many spatters were generated and irregular toes were formed.

Although the gas-shielded arc welding methods in the preferred embodiments of the present invention and the beads in examples have been described, many changes and variations are possible therein. It is therefore to be understood that the present invention may be practiced otherwise than those specifically described herein without departing from the scope and spirit thereof.

What is claimed is:

1. A gas-shielded arc welding method using a shielding gas and a solid wire for pulsation welding, wherein the solid wire contains 0.040 to 0.200% by mass S, 0.20 to 1.50% by mass Si, 0.50 to 2.50% by mass Mn, 0.15% by mass or below C, 0.025% by mass or below P and other elements including Fe and unavoidable impurities,
a pulsating current used for pulsation welding has a peak current Iₚ of 350 A or above and a pulse peak duration Tₚ between 0.5 and 2.0 ms, and
the shielding gas is a mixed gas containing 75 to 98% by volume Ar and others including at least either of CO₂ and O₂.

2. A gas-shielded arc welding method using a shielding gas and a solid wire for pulsation welding, wherein the solid wire contains 0.040 to 0.200% by mass S, 0.20 to 1.50% by mass Si, 0.50 to 2.50% by mass Mn, 0.15% by mass or below C, 0.025% by mass or below P, 0.10% by mass or below Ti, 0.20% by mass or below Al, 0.50% by mass or below Mo, 0.30% by mass or below Nb, 0.30% by mass or below V, 1.00% by mass or below Cr, 1.00% by as or below Ni and other elements including Fe and unavoidable impurities,
a pulsating current used for pulsation welding has a peak current Iₚ of 350 A or above and a pulse peak duration Tₚ between 0.5 and 20 ms, and
a shielding gas is a mixed gas containing 75 to 98% by volume Ar and others including at least either of CO₂ and O₂.
